(19) United States
(12) Patent Application Publication
(10) Pub. No.: US 2006/0266118 A1
(43) Pub. Date: Nov. 30, 2006

(54) Capacitive sensor with damping

(76) Inventors: Timothy J. Denison, Minneapolis, MN (US); David C. Hollocher, Norwood, MA (US); John A. Geen, Tewksbury, MA (US)

Correspondence Address: BROMBERG & SUNSTEIN LLP, 125 SUMMER STREET, BOSTON, MA, 02110-1618, US

(21) Appl. No.: 11/394,386

(22) Filed: Mar. 28, 2006

Related U.S. Application Data
(60) Provisional application No. 60/666,090, filed on Mar. 29, 2005.

(51) Int. Cl. G01P 15/125

(52) U.S. Cl. 73/514.32

(57) ABSTRACT

A capacitive accelerometer. The capacitive accelerometer includes a first fixed electrode and second fixed electrode. The first fixed electrode is separated from the second fixed electrode by a gap. A movable electrode is positioned between the first and second fixed electrodes, the movable electrode being movable between the first and second fixed electrodes. The movable electrode is dimensioned to produce a squeeze damping effect between the movable and fixed electrodes to damp movement of the movable electrode. Circuitry determines the position of the movable electrode in any position across substantially the entire gap between the first and second fixed electrodes.

### CROSS REFERENCE TO RELATED APPLICATIONS

The present application claims priority from U.S. Provisional Patent Application 60/666,090, entitled “Capacitive Sensor with Damping and Electrostatic Force Manager,” filed Mar. 29, 2005, the contents of which are incorporated herein by reference in its entirety.

### TECHNICAL FIELD

The invention generally relates to capacitive sensing devices and, more particularly, the invention relates to minimizing signal degradation of capacitive sensing devices.

### BACKGROUND ART

A wide variety of applications use capacitive sensors to detect some environmental quality. For example, micromachined accelerometers commonly use capacitive sensing to sense acceleration for a variety of applications, including acceleration that occurs as a result of an automobile accident (for deploying an airbag), and acceleration resulting from an earthquake (to automatically shut off a gas line).

One type of micromachined accelerometer has a movable mass suspended over a substrate by supporting tethers. The mass, which is essentially parallel to the substrate, has an elongated body and a plurality of fingers that perpendicularly extend away from the body. Each of these fingers (referred to as “movable fingers”) is positioned between two stationary fingers formed in the plane of the mass. Each movable finger, and the stationary fingers on either side of each movable finger, include an electrode and form a differential capacitor cell that collectively form an aggregate differential capacitor. A structure of this type is shown, for example, in U.S. Pat. No. 5,345,824, which is incorporated herein by reference in its entirety.

Accelerometers generally make linear measurements for mass displacements that are a small fraction of their total possible displacement. Undesirably, however, larger mass displacements often introduce nonlinearities. Large mass displacements even may saturate the sensor or the signal chain.

Unintended electrostatic forces between fingers may further corrupt the sensors.

### SUMMARY OF THE INVENTION

In accordance with a first aspect of the invention, a capacitive accelerometer includes a first fixed electrode and second fixed electrode. The first fixed electrode is separated from the second fixed electrode by a gap. A movable electrode is movably positioned between the first and second fixed electrodes. The movable electrode is dimensioned to produce a squeeze damping effect between the movable and fixed electrodes to damp movement of the movable electrode. Circuitry determines the position of the movable electrode in any position across substantially the entire gap between the first and second fixed electrodes.

In accordance with related embodiments of the invention, the circuitry may remain unsaturated across substantially the entire gap. The circuitry may saturate if the movable electrode is manually forced to contact one of the first and second fixed electrodes. The squeeze damping effect may prevent the movable electrode from contacting the first and second fixed electrodes during a predetermined range of dynamic operation.

In accordance with further related embodiments of the invention, the movable electrode may be spaced a rest distance from the first fixed electrode when no external force is applied, with the movable electrode formed from a movable mass suspended above a substrate on a device layer. The device layer has a device layer thickness, with the ratio of the thickness to the rest distance being equal to or greater than 4:1.

In accordance with still further related embodiments, the accelerometer may further include electrostatic force management circuitry for reducing parasitic electrostatic forces. The electrostatic force management circuitry may include 1) a first driver for providing a first periodic signal to the first fixed electrode, and (2) a second driver for providing a second periodic signal to the second fixed electrode. The first and second period signals vary as a function of the position of the movable electrode, and are substantially 180 degrees out of phase. The first periodic signal and the second periodic signal may vary between 0 and a supply voltage V_{DD} when the movable electrode is in any position across substantially the entire gap without contacting the first and second fixed electrodes. The first and second periodic signals may vary between ¼ V_{DD} and ¾ V_{DD} when no external force is applied.

In accordance with another aspect of the invention, a method of sensing acceleration includes providing a first fixed electrode and second fixed electrode, the first fixed electrode separated from the second fixed electrode by a gap. A movable electrode is provided that is positioned and movable between the first and second fixed electrodes. The movable electrode is dimensioned to produce a squeeze damping effect between the movable and fixed electrodes to damp movement of the movable electrode. A position of the movable electrode is determined in any position across substantially the entire gap between the first and second fixed electrodes.

In accordance with related embodiments of the invention, the movable electrode may be prevented from contacting the first and second fixed electrodes using the squeeze damping effect. The movable electrode may be spaced a rest distance from the first fixed electrode when no external force is applied, with the movable electrode formed from a movable mass suspended above a substrate on a device layer. The device layer has a device layer thickness, the ratio of the thickness to the rest distance being equal to or greater than 4:1.

In accordance with further related embodiments of the invention, parasitic electrostatic forces between the moving electrode and the first and second fixed electrodes may be reduced. Reducing the parasitic electrostatic forces may include 1) providing a first periodic signal to the first fixed electrode, and 2) providing a second periodic signal to the second fixed electrode. The first and second period signals vary as a function of the position of the movable electrode and are substantially 180 degrees out of phase. Providing the first and second periodic signals may include varying the first and second periodic signals between 0 and a supply voltage V_{DD} when the movable electrode is in any position across substantially the entire gap but not contacting the first and second fixed electrodes. The first and second periodic signals may vary between ¼ V_{DD} and ¾ V_{DD} when no external force is applied.

In accordance with another aspect of the invention, a capacitive accelerometer includes a first fixed electrode and second fixed electrode. The first fixed electrode is separated from the second fixed electrode by a gap. A movable electrode is movably positioned between the first and second fixed electrodes. The movable electrode is dimensioned to produce a squeeze damping effect between the movable and fixed electrodes to damp movement of the movable electrode. The accelerometer includes means for determining the position of the movable electrode in any position across substantially the entire gap between the first and second fixed electrodes.

In related embodiments of the invention, the squeeze damping effect prevents the movable electrode from contacting the first and second fixed electrodes during a predetermined range of dynamic operation. The movable electrode may be spaced a rest distance from the first fixed electrode and the second fixed electrode when no external force is applied, with the movable electrode formed from a movable mass suspended above a substrate on a device layer. The device layer has a device layer thickness, the ratio of the thickness to the rest distance being equal to or greater than 4:1.

In further related embodiments of the invention, the accelerometer includes means for reducing parasitic electrostatic forces between the moving electrode and first and second fixed electrodes. The means for reducing parasitic electrostatic forces may include 1) a first driver for providing a first periodic signal to the first fixed electrode, and 2) a second driver for providing a second periodic signal to the second fixed electrode. The first and second period signals vary as a function of the position of the movable electrode, and are substantially 180 degrees out of phase. The first and second period signals may vary between 0 and a supply voltage V_{DD} when the movable electrode is in any position across substantially the entire gap without contacting the first and second fixed electrodes. The first and second periodic signals may vary between ¼ V_{DD} and ¾ V_{DD} when no external force is applied.

### BRIEF DESCRIPTION OF THE DRAWINGS

The foregoing features of the invention will be more readily understood by reference to the following detailed description, taken with reference to the accompanying drawings, in which:

FIG. 1 schematically shows two exemplary output waveforms of an accelerometer.

FIG. 2 schematically shows a cross-sectional view of an accelerometer that may be configured in accordance with illustrative embodiments of the invention.

FIG. 3 schematically shows a plan view of the accelerometer shown in FIG. 2.

FIG. 4 is a graph of an exemplary accelerometer showing damping in kg/s versus displacement in micrometers, in accordance with one embodiment of the invention.

FIG. 5 is a graph illustrating a small-signal transfer function of an exemplary accelerometer when the damping from the graph of FIG. 4 is about 5*10ˆ−5, in accordance with one embodiment of the invention.

FIG. 6 is a graph illustrating a small-signal transfer function of an exemplary accelerometer when the damping in FIG. 4 is about 5*10ˆ−4.

FIG. 7 is a schematic block diagram of a sensor with driver circuitry.

FIG. 8 is a schematic block diagram of driver circuitry.

FIG. 8(a) shows graphs of waveforms on the electrodes for the circuitry of FIG. 8.

FIG. 9 shows alternative graphs of waveforms for the circuitry of FIG. 8.

### DETAILED DESCRIPTION OF SPECIFIC EMBODIMENTS

In illustrative embodiments, a capacitive sensor determines a position of a mechanically dampened, movable electrode across a large fraction of total possible displacement relative to a stationary electrode. In addition, the capacitive sensor is configured to substantially eliminate the potentially distorting effects of electrostatic forces between the movable and stationary electrodes. Details of illustrative embodiments are discussed below.

Among other things, the capacitive sensor may be a MEMS accelerometer or MEMS gyroscope. Exemplary MEMS gyroscopes are discussed in greater detail in U.S. Pat. No. 6,505,511, which is assigned to Analog Devices, Inc. of Norwood, Mass. Exemplary MEMS accelerometers are discussed in greater detail in U.S. Pat. No. 5,939,633, which also is assigned to Analog Devices, Inc. of Norwood, Mass. The disclosures of U.S. Pat. Nos. 5,939,633 and 6,505,511 are incorporated herein, in their entireties, by reference.

Although the capacitive sensor is discussed above as an inertial sensor, principles of illustrative embodiments may apply to other MEMS devices, such as pressure sensors and microphones. Accordingly, discussion of an inertial sensor is exemplary and not intended to limit the scope of various embodiments of the invention.

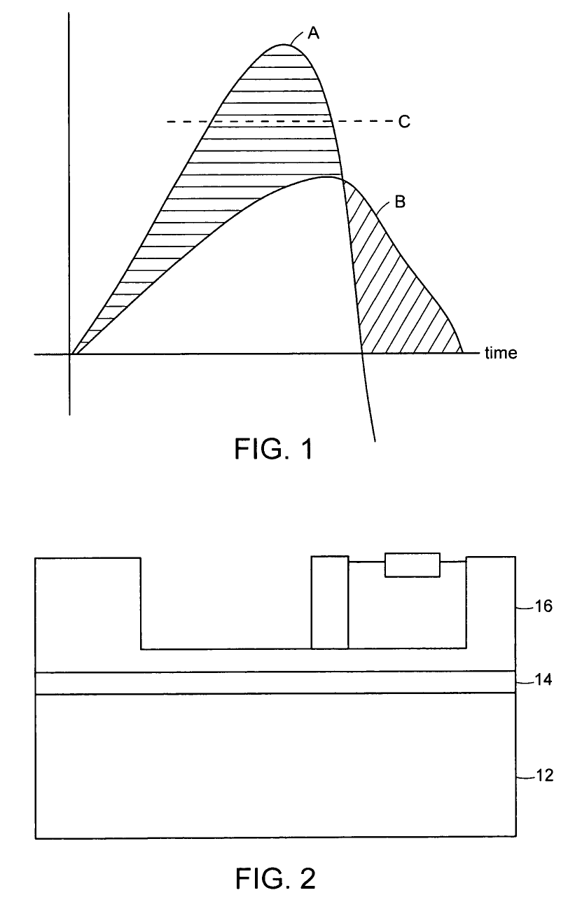

For simplicity, however, illustrative embodiments are discussed as being applied to an accelerometer. To that end, FIG. 1 schematically shows two exemplary output waveforms of an accelerometer. Both waveforms represent the acceleration measurements. Specifically, waveform A represents the acceleration measured by an accelerometer without damping or clipping, while waveform B represents the acceleration measured by an accelerometer with damping and electrostatic force management circuitry. In either case, an integrator module (e.g., hardware of software) integrates each of these waveforms to derive velocity data.

In accordance with illustrative embodiments, the area under both waveforms A (without clipping) and B are substantially equal. Accordingly, the hatched area of waveform A should equal the hatched area of waveform B. To that end, the dimensions of the spacing between the fixed and stationary fingers are selected, relative to the thickness of the primary portion of the sensor, to ensure that a film of air (or injected gas, as the case may be) sufficiently dampens movement of a movable member. Note that dashed line C represents an exemplary overload limit of an accelerometer. Waveform A is clipped at the overload limit, consequently distorting the derived velocity data. Due to damping, waveform B advantageously remains under this overload limit, such that clipping does not occur and accurate velocity data is obtained.

Damping from films of gas or other fluids is very effective because it is very non-linear, becoming very large as the fingers move together. The surprising result that such damping conserves the velocity is mathematically shown as follows. Generally, let the accelerometer have a mass m, a spring constant K, and damping Dx, with Dx being an arbitrary function of displacement x. Consider the time dT to traverse a small distance dx. Under the influence of an applied acceleration event,

$$dTa = dx \cdot \frac{Dx}{m \cdot a - K \cdot x} \qquad ( 1 )$$

where ·a is the acceleration at that time. On the subsequent return through that point,

$$dTk = dx \cdot \frac{Dx}{K \cdot x} . \qquad ( 2 )$$

The accelerometer attributes a certain acceleration,

$$\frac{K \cdot x}{m} , \qquad ( 3 )$$

to the displacement vector irrespective of the sign or magnitude of its time differential, so the velocity change corresponding to traversing dx is

$$Δ V = \frac{K \cdot x}{m} \cdot ( dTa + dTk ) . \qquad ( 4 )$$

Substituting for dTk,

$$Δ V = \frac{K \cdot x}{m} \cdot dTa \cdot ( 1 + \frac{m \cdot a - K \cdot x}{K \cdot x} ) = a \cdot dTa , \qquad ( 5 )$$

which is the real input velocity change. If the velocity change is correct for every x, then it follows that the integral is also correct, and the correct measure of the total velocity change is obtained, provided the positional readout is correct, even though the information is time delayed.

In even more detail, starting with the squeeze film damping formula,

$$Dx = \frac{Do}{2} \cdot [ \frac{1}{{( 1 - \frac{x}{g} )}^{3}} + \frac{1}{{( 1 + \frac{x}{g} )}^{3}} ] \qquad ( 6 )$$

for a displacement x, in gap g, the displacement equation

$$\frac{ⅆ}{ⅆ t} x = \frac{ma - kx}{Dx} \qquad ( 7 )$$

for a raised cosinusoidal shock input of amplitude a0 and half width τ is solved.
That is,

$$a = \frac{ao}{2} \cdot ( 1 - cos ( π \cdot \frac{t}{τ} ) ) when 0 < t < 2 \cdot τ and a = 0 when t > 2 \cdot τ . \qquad ( 8 )$$

The real velocity change is then

$${\int }_{0}^{2 \cdot τ} a ⅆ t = ao \cdot τ \qquad ( 9 )$$

while the measured velocity change is

$$Δ V = {\int }_{0}^{∞} \frac{k}{m} \cdot x ⅆ t \qquad ( 10 )$$

where k/m is the ‘calibration’ of the displacement to acceleration, nominally a spring constant to mass ratio.

If the damping were linear then the gap would just be closed for

$$a o \cdot τ = \frac{g \cdot D o}{m} . \qquad ( 11 )$$

The real delta velocity input can be normalized to this as a ‘stops overload ratio’. This system of equations has been solved numerically with overload ratios from 0.1 to 20 (at which, for example, the gap is 85% consumed) and provides correct values for the measured velocity change.

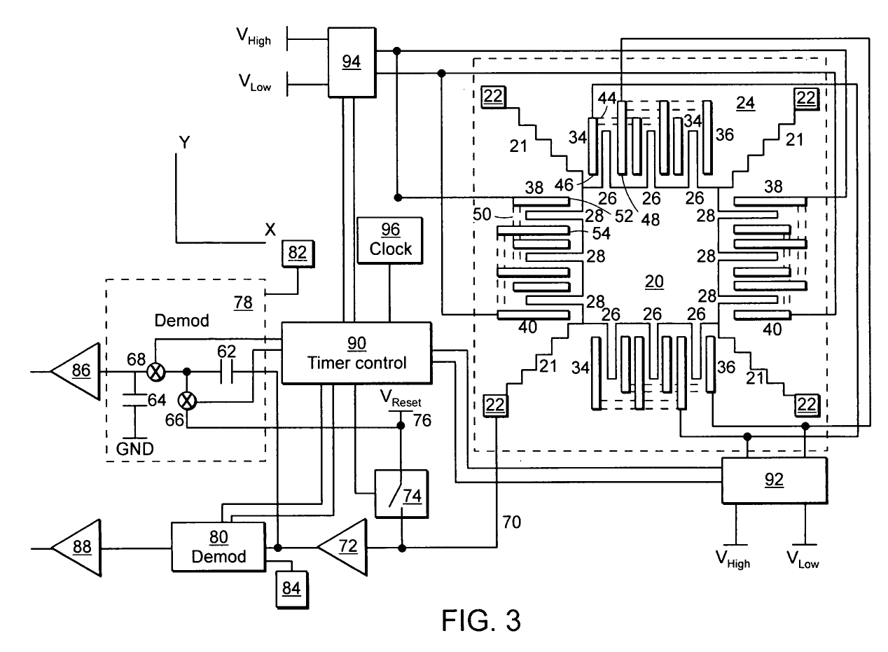

Illustrative embodiments may be formed using silicon-on-insulator wafers. FIG. 2 schematically shows a cross-sectional view of an accelerometer 10 formed on a silicon-on-insulator wafer. Such an accelerometer 10 is considered to have three primary layers; namely, 1) a handle wafer 12 for supporting the entire structure, 2) an insulator layer 14, and 3) a device layer 16 having both movable and stationary fingers. FIG. 3, which is reproduced from U.S. Pat. No. 5,939,633, schematically shows a top view of the same accelerometer. As shown, the device layer has a movable mass 20 suspended by a plurality of flexible suspension arms 21. Movable fingers 26 and 28 extend from the mass 20, and are selectively positioned between stationary fingers 34, 36, 38, and 40.

As noted above, each movable finger forms a capacitor cell with two of the stationary fingers on each of its sides. Each movable finger in a capacitor cell therefore has one movable finger between first and second stationary fingers. For a given capacitor cell, the movable finger is considered to have a first associated distance (D1) between it and the first stationary finger, and a second associated distance (D2 ) between it and the second stationary finger. These distances D1 and D2 illustratively are equal when at rest. The distances D1 and D2 should be selected relative to the thickness (T) of the device layer and/or the thickness of the movable finger to ensure 1) that damping is high enough to so that second order frequency response is not too peaky (i.e., it does not increase in amplitude significantly near the resonant frequency), 2) that damping is low enough so that the bandwidth is not significantly reduced below the resonant frequency.

This relative distance can be selected based upon a number of empirical or other methods that provide the desired results. For example, for a given implementation, a T/D ratio of equal to or greater than 4:1 (e.g., a thickness of 8 microns and a gap distance of 2 microns) should provided satisfactory results. Other embodiments may have, without limitation, a T/D ratio equal to or greater than 5:1 or 10:1. Such implementation should provide a “squeeze film damping” effect that satisfactorily preserves the true velocity reading as discussed above with regard to FIG. 1, while maintaining satisfactory sensitivity. Of course, to determine an appropriate ratio, other factors should be taken into account, such as the resonant frequency of the sensor and the overlap area of the fixed and moving fingers. In illustrative embodiments, the damping is selected so that the Q factor of the sensor is substantially equal to or somewhat less than unity.

Illustrative embodiments provide the desired damping effect in a manner that enables the movable fingers to travel as close to the fixed fingers as possible without making contact. Contact between the movable fingers and the fixed fingers undesirably may cause saturation and/or errors in the derived velocity. Sufficient damping to prevent such contact, as provided by the above-described narrow, deep gaps (i.e., a high aspect ratio) between the movable and fixed fingers, should maximize the bandwidth of both the sensor and the signal. This maximization is determined based upon a number of factors, including the composition of the gas within the device and anticipated acceleration signals. An exemplary high-aspect ratio gyroscope is described in U.S. Pat. No. 6,626,039, which is incorporated herein by reference in its entirety.

For small displacements, the damping illustratively only minimally changes. More specifically, in such embodiments, when the aspect ratio of the gap between the fixed and moving plates is low, damping is low. For example, a ten micrometer thick sensor with a gap of 2 micrometers at zero displacement has an aspect ratio of 5. When the moving plate is just 0.1 um away from the fixed plate, the aspect ratio is 10/0.1, or 100 and the damping is high.

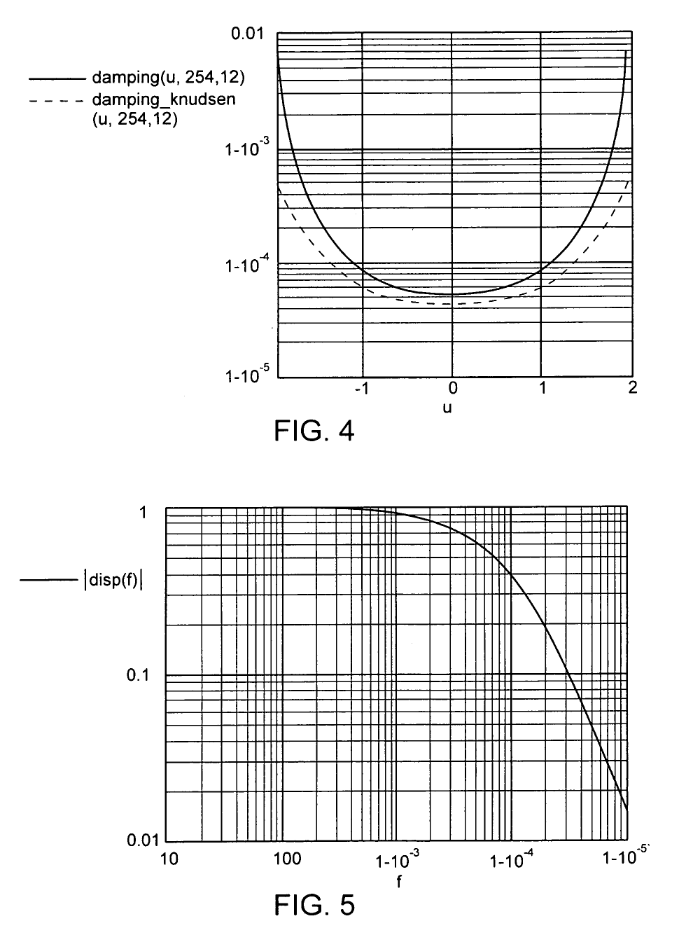

Damping may be calculated in a number of ways, such as by using finite element analysis. FIGS. 4-6 are graphs based on a MathCAD analysis of the damping of an illustrative sensor built in silicon on insulator technology. These graphs are for illustrative purposes only and thus, not intended to limit all embodiments. The exemplary sensor has a nominal gap of 2 um and a thickness of 10 um.

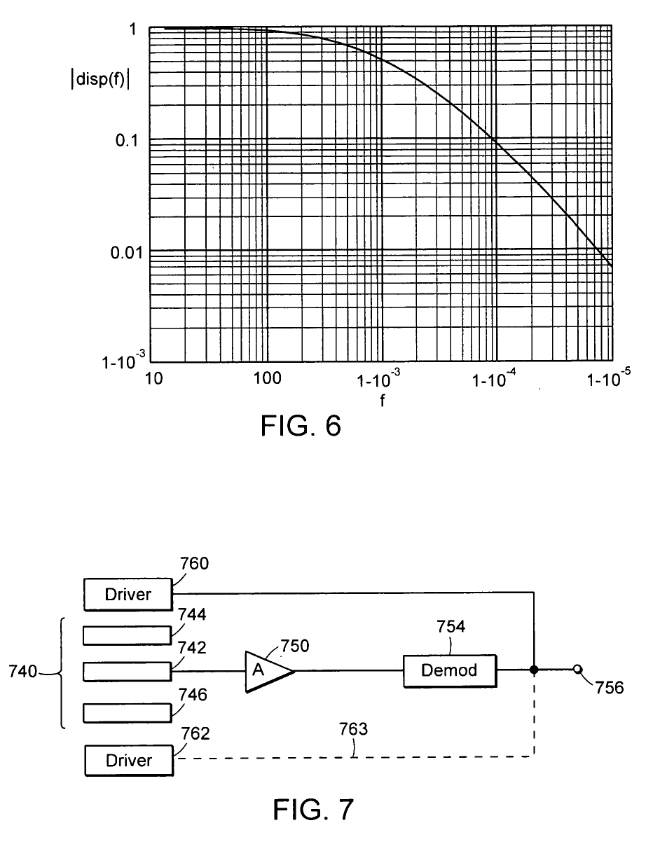

FIG. 4 is a graph that shows damping in kg/s versus displacement in micrometers. FIG. 5 is a graph illustrating a small-signal transfer function of a 12.5 kHz sensor when the damping from the graph of FIG. 4 is about 5*10ˆ−5, in accordance with one embodiment of the invention. For such a sensor, the bandwidth (defined where the amplitude is about 0.7) is indeed approximately 12.5 kHz. FIG. 6 is a graph illustrating a small-signal transfer function when the illustrative sensor is displaced such that the damping in FIG. 4 is about 5*10ˆ−4. In this case, the −3dB bandwidth is only about 450 Hz.

Accordingly, damping illustratively is low for small displacements, (e.g., corresponding to a few hundred gees or less). This allows the bandwidth of the sensor to be as high as the resonant frequency (if the electronics are also fast enough). Illustrative embodiments thus should produce accurate small signal outputs for certain acceleration values (e.g., up to tens of kHz), while also preserving velocity information even when acceleration is high enough to cause the sensor saturate in the absence of damping.

Damping also illustratively is high at large displacements, thus ensuring that the sensor does not hit a mechanical stop under expected operating conditions. For example, in FIG. 6, bandwidth is reduced to about 450 Hz due to the increased damping, which is a result of the large sensor displacement. These qualities therefore should preserve the velocity information.

Accordingly, referring to the above graphs as examples, when a 20 kHz sensor moves about 0.63 nm/gee, or 0.063 um/100 gee, displacement is less than a few tenths of a micron and the bandwidth is limited by the resonant frequency of the sensor. At 2000 g, however, the displacement is about 1.26 um and the damping is increased significantly, to about 1e-4.

Electrostatic management circuitry (discussed below) substantially mitigates one potential source of error when doing this. Specifically, large displacements can cause a change in electrostatic force between the moving and fixed fingers - - - and this force is not proportional to the applied acceleration. In fact, as the displacement increases, the electrostatic force increases even more. If the displacement is large enough, it is possible that the electrostatic force could be stronger than the restoring spring force, which would cause the moving portion of the sensor to snap to the fixed portion. The moving portion thus could be electrostatically stuck to the fixed portion for some time, such as until the power is turned off.

Accordingly, further enhancing accelerometer performance, illustrative embodiments also incorporate circuitry that substantially eliminates adverse effects caused by electrostatic forces. In particular, as known by those skilled in the art, electrostatic forces between the fixed and stationary fingers can have a serious impact on accelerometer performance. A net electrostatic force on the moving finger would be misinterpreted as an inertial force and cause the accelerometer to derive the wrong velocity integral.

Electrostatic force between two plates of a capacitor is defined by the following equation:
F_{E}=(E A V²)/(2D²) (1)

where: E=permittivity constant; A=area of fingers; V=voltage of capacitor; and D=distance between fingers.

Illustrative embodiments vary the voltage linearly with the distance between the fingers to ensure that electrostatic force does not impact finger movement. Specifically, E and A are constant, and the distance is controlled by movement of the accelerometer. Accordingly, feedback circuitry within the accelerometer ensures that the voltage V between the fingers remains linearly proportional to the distance D. Stated another way, illustrative embodiments comply with the following equation:
V/D=constant (2)
By keeping V/D constant, the net electrostatic force on the moving finger is zero.

Among other ways, the circuitry used to maintain this relationship can be similar to that disclosed in U.S. Pat. No. 6,761,069 (assigned to Analog Devices, Inc.) and U.S. Pat. No. 6,530,275 (assigned to Analog Devices, Inc.), the disclosures of which are incorporated herein, and their entireties, by reference. The circuitry also may be similar to that disclosed in U.S. patent application Ser. No. 10/818,863 (assigned to Analog Devices, Inc.), the disclosure of which also is incorporated herein, and its entirety, by reference.

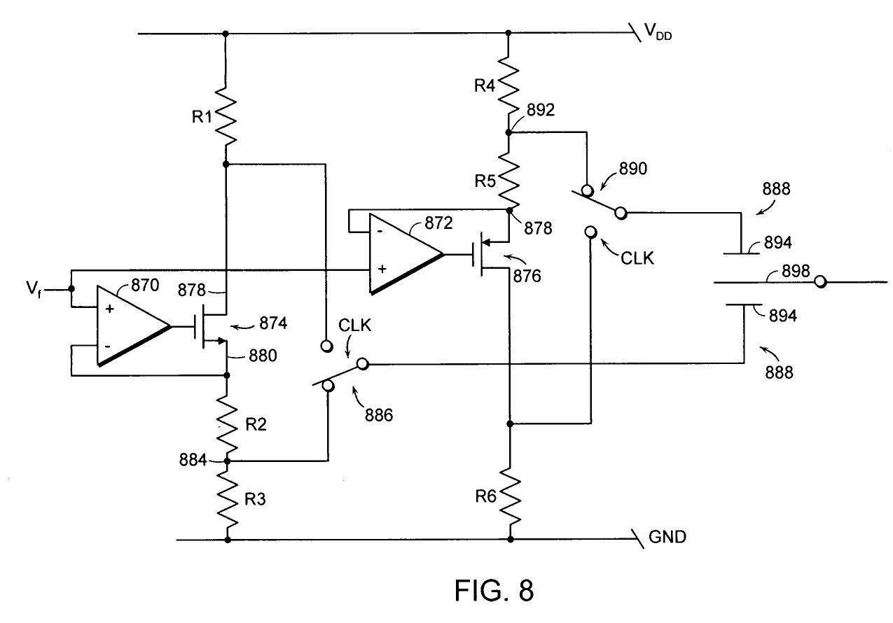

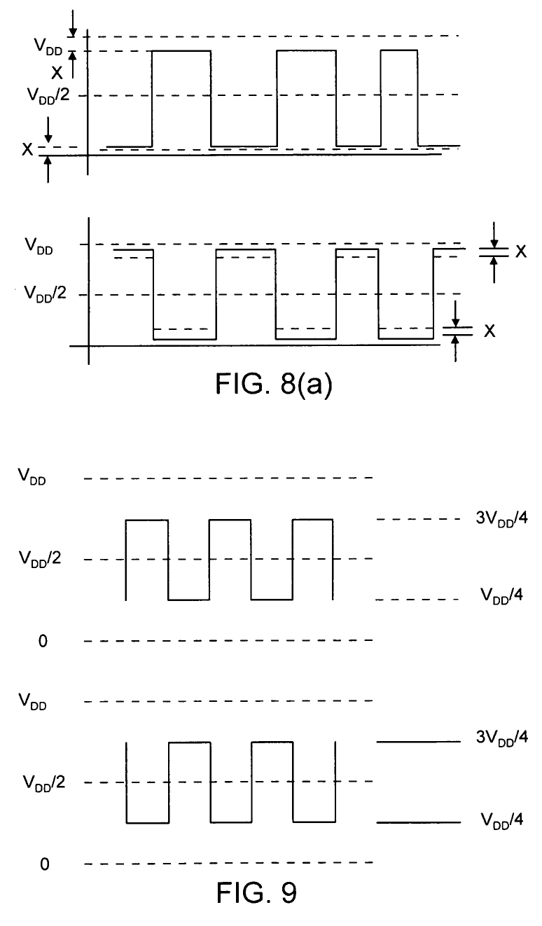

More specifically, FIG. 7-8, which are reproduced from U.S. Pat. No. 5,939,633, shows sensor circuitry/waveforms that may be used for electrostatic force management. Referring to FIG. 7, the sensor 740 includes a movable electrode 742 that is positioned between a first electrode 744 and a second electrode 746 to form a differential capacitor, as described in above embodiments. Movable electrode 742 is coupled to a high gain AC amplifier 750 and a demodulator 754, the output of which is provided to an output terminal 756. Drivers 760 and 762 each provide a high frequency (e.g., 100 KHz) carrier, preferably a square wave. The carrier signals are equal or similar in amplitude and 180° out of phase. Output terminal 756 is coupled to driver 760, and it is preferably also coupled to driver 762 as indicated by dashed line 763.

FIG. 8 illustrates a more detailed view of drivers 760 and 762 (shown combined together) for providing signals to first and second fixed electrodes 888 and 894. A feedback voltage V_{f} is provided to non-inverting inputs of opamps 870 and 872. The outputs of opamps 870 and 872 are connected to the gates of n-type transistor 874 and p-type transistor 876, respectively. Transistor 874 has a drain terminal coupled to a supply voltage V_{DD} through a resistor R1. A source terminal 880 of transistor 874 is coupled to the inverting terminal of opamp 870 and to ground through resistors R2 and R3. The drain of transistor 874 and a node 884 between resistors R2 and R3 are each coupled to a clocked switch 886, the output of which is connected to first fixed electrode 888.

Transistor 876 has a source terminal 878 coupled to supply voltage V_{DD} through resistors R4 and R5, and coupled to the inverting terminal of opamp 872. The drain of transistor 876 is connected to ground through resistor R6. The drain of transistor 876 and a node 892 between resistors R4 and R5 are each coupled to a clocked switch 890, the output of which is connected to second fixed electrode 894.

The operation of the circuitry in FIG. 8 is described also with reference to the waveforms in FIG. 8A. Assume exemplary resistor values are R1=R3=R4=R6=1 kohm; and R2=R4=40 kohm. When there is no external acceleration on movable electrode 898, the signal V_{f} that is fed back equals V_{DD}/2. Voltage V_{f} also appears at the source of transistor 874, which means that the voltage across resistor R3 is (V_{f})(R3)/(R2+R3). Because R3=R1, the voltage drops across resistors R3 and R1 are the same. Resistor R2 has a value that is much higher than that of resistor R3, so the voltage across resistors R1 and R3 is low relative to V_{f}. If the voltage drop across resistors R1 and R3 is x, clocked switch 886 generates a square wave that alternates in amplitude between x and V_{DD}−x. The circuitry for providing voltage to clocked switch 890 is similar to that for clocked switch 886, except that in this case V_{f} is referenced to supply voltage V_{DD} rather than being referenced to ground. Assuming that V_{DD} equals 5 volts, and therefore with no acceleration V_{f}=2.5 volts, the voltage x across resistors R1 and R3 is about 60 millivolts, so the clocked signals alternate between 0.06 volts and 4.94 volts. Referring also to FIG. 8A, as V_{f} increases or decreases in response to movement by electrode 898, one of the square waves will have a higher maximum and lower minimum, and the other will have a lower maximum and a higher minimum. For each electrode, the voltage is still centered on V_{DD}/2.

A positive V_{f} means that movable electrode 898 moves closer to fixed electrode 888, thus requiring a higher drive signal on fixed electrode 894 in order to maintain the equality of the electrostatic forces between the movable electrode 898 and each of the fixed electrodes without a differential voltage output on electrode 898. In various embodiments, the 60 millivolts above ground and below V_{DD} provide room for such output.

However, in illustrative embodiments of the invention, a greater output range is required. As described above, damping may advantageously allow the sensor to be dynamically operated when the movable electrode is in any position across substantially the entire gap between the first and second fixed electrodes. Thus, during operation, the gap on one side between the movable electrode and fixed electrode may nearly double, while the gap on the other side drops to nearly zero.

To account for this full range of operation, FIG. 9 shows alternative waveforms that may be provided by the electrostatic force management circuitry, in accordance to one embodiment of the invention. When no external force is applied to the sensor and the movable electrode is at a rest distance from the first fixed electrode, the first and second periodic signals varies between ¼ V_{DD} and ¾ V_{DD}. This allows the driver signals to either substantially double in value or substantially decrease by a whole value. The resistors R2 and R5 of FIG. 8 are removed in order to achieve this.

It should be noted that although “squeeze film dampening” is discussed, various embodiments can use other types of damping that are sufficient to keep the fingers from making contact. Accordingly, various embodiments should maintain substantially accurate measured velocity data for a number of types of accelerometers in high acceleration and high resolution environments.

Accordingly, in illustrative embodiments, small-signal bandwidth can be approximately as high as the resonant frequency of the sensor. Even though the large-signal bandwidth is lower in many instances, illustrative embodiments still should preserve the velocity information.

Although the above discussion discloses various exemplary embodiments of the invention, it should be apparent that those skilled in the art can make various modifications that will achieve some of the advantages of the invention without departing from the true scope of the invention. For example, the damping mechanism, the position sensor and the electrostatic management need not all be implemented using the same fingers, or even all with fingers, although that is particularly elegant. Other variations and modifications of the embodiments described above are intended to be within the scope of the present invention as defined in the appended claims.

What is claimed is:

1. A capacitive accelerometer comprising:
a first fixed electrode and second fixed electrode, the first fixed electrode separated from the second fixed electrode by a gap;
a movable electrode positioned between first and second fixed electrodes, the movable electrode being movable between the first and second fixed electrodes, the movable electrode dimensioned to produce a squeeze damping effect between the movable and fixed electrodes to damp movement of the movable electrode; and
circuitry for determining the position of the movable electrode in any position across substantially the entire gap between the first and second fixed electrodes.

2. The accelerometer according to claim 1, wherein the circuitry remains unsaturated across substantially the entire gap.

3. The accelerometer according to claim 2, wherein the circuitry saturates if the movable electrode is manually forced to contact one of the first and second fixed electrodes.

4. The accelerometer according to claim 1, wherein the squeeze damping effect prevents the movable electrode from contacting the first and second fixed electrodes during a predetermined range of dynamic operation.

5. The accelerometer according to claim 1, wherein the movable electrode is spaced a rest distance from the first fixed electrode when no external force is applied, the movable electrode formed from a movable mass suspended above a substrate on a device layer, the device layer having a device layer thickness, the ratio of the thickness to the rest distance being equal to or greater than 4:1.

6. The accelerometer according to claim 5, wherein the ratio is equal to or greater than 10:1.

7. The accelerometer according to claim 1, further comprising electrostatic force management circuitry for reducing parasitic electrostatic forces.

8. The accelerometer according to claim 7, wherein the electrostatic force management circuitry includes:
a first driver for providing a first periodic signal to the first fixed electrode;
a second driver for providing a second periodic signal to the second fixed electrode, the first and second period signals varying as a function of the position of the movable electrode and being substantially 180 degrees out of phase.

9. The accelerometer according to claim 8, wherein the first periodic signal and the second periodic signal each vary between 0 and a supply voltage V_{DD} when the movable electrode is in any position across substantially the entire gap without contacting the first and second fixed electrodes.

10. The accelerometer according to claim 9, wherein the first and second periodic signals each vary between ¼ V_{DD} and ¾ V_{DD} when no external force is applied.

11. A method of sensing acceleration, the method comprising:
providing a first fixed electrode and second fixed electrode, the first fixed electrode separated from the second fixed electrode by a gap;
providing a movable electrode positioned between first and second fixed electrodes, the movable electrode being movable between the first and second fixed electrodes, the movable electrode dimensioned to produce a squeeze damping effect between the movable and fixed electrodes to damp movement of the movable electrode; and
determining a position of the movable electrode in any position across substantially the entire gap between the first and second fixed electrodes.

12. The method according to claim 11, the method further comprising preventing the movable electrode from contacting the first and second fixed electrodes using the squeeze damping effect.

13. The method according to claim 11, further comprising spacing the movable electrode a rest distance from the first fixed electrode when no external force is applied, the movable electrode formed from a movable mass suspended above a substrate on a device layer, the device layer having a device layer thickness, the ratio of the thickness to the rest distance being equal to or greater than 4:1.

14. The method according to claim 11, further comprising reducing parasitic electrostatic forces between the moving electrode and the first and second fixed electrodes.

15. The method according to claim 14, wherein reducing parasitic electrostatic forces includes:
providing a first periodic signal to the first fixed electrode;
providing a second periodic signal to the second fixed electrode, the first and second period signals varying as a function of the position of the movable electrode and being substantially 180 degrees out of phase.

16. The method according to claim 15, wherein providing the first and second periodic signals includes varying the first and second periodic signals between 0 and a supply voltage V_{DD} when the movable electrode is in any position across substantially the entire gap but not contacting the first and second fixed electrodes, and wherein the first and second periodic signals each vary between ¼ V_{DD} and ¾ V_{DD} when no external force is applied.

17. A capacitive accelerometer comprising:
a first fixed electrode and second fixed electrode, the first fixed electrode separated from the second fixed electrode by a gap;
a movable electrode positioned between first and second fixed electrodes, the movable electrode being movable between the first and second fixed electrodes, the movable electrode dimensioned to produce a squeeze damping effect between the movable and fixed electrodes to damp movement of the movable electrode; and
means for determining the position of the movable electrode in any position across substantially the entire gap between the first and second fixed electrodes.

18. The accelerometer according to claim 17, wherein the squeeze damping effect prevents the movable electrode from contacting the first and second fixed electrodes during a predetermined range of dynamic operation.

19. The accelerometer according to claim 17, wherein the movable electrode is spaced a rest distance from the first fixed electrode and the second fixed electrode when no external force is applied, the movable electrode formed from a movable mass suspended above a substrate on a device layer, the device layer having a device layer thickness, the ratio of the thickness to the rest distance being equal to or greater than 4:1.

20. The accelerometer according to claim 17, further comprising includes means for reducing parasitic electrostatic forces between the moving electrode and first and second fixed electrodes.

21. The accelerometer according to claim 21, wherein the means for reducing parasitic electrostatic forces includes:
a first driver for providing a first periodic signal to the first fixed electrode;
a second driver for providing a second periodic signal to the second fixed electrode, the first and second period signals varying as a function of the position of the movable electrode and being substantially 180 degrees out of phase, wherein the first periodic signal and the second periodic signal vary between 0 and a supply voltage V_{DD} when the movable electrode is in any position across substantially the entire gap without contacting the first and second fixed electrodes, and wherein the first and second periodic signals each vary between ¼ V_{DD} and ¾ V_{DD} when no external force is applied.
